(19) United States
(12) Patent Application Publication
(10) Pub. No.: US 2004/0047535 A1
(43) Pub. Date: Mar. 11, 2004

(54) Enhanced fiber-optic sensor

(76) Inventor: Ljerka Ukrainczyk, Painted Post, NY (US)

Correspondence Address: CORNING INCORPORATED, SP-TI-3-1, CORNING, NY, 14831

(21) Appl. No.: 10/238,098

(22) Filed: Sep. 9, 2002

(51) Int. Cl. G02B 6/00

(52) U.S. Cl. 385/12; 385/33

(57) ABSTRACT

A fiber-optic sensor includes one or more fiber-optic sensor probes, a light source for sending light into a fiber-optic sensor probe, and a light detector for detecting light from a fiber-optic sensor probe. In one embodiment, the fiber-optic sensor probe includes an optical fiber terminated with a lens. In another embodiment, the fiber-optic sensor probe includes an optical fiber, a lens, and an elongated region formed between the optical fiber and the lens.

### BACKGROUND OF INVENTION

1. Field of the Invention

The invention relates generally to methods and devices for sensing and detecting stimuli. More specifically, the invention relates to a fiber-optic sensor having enhanced sensitivity.

2. Background Art

Fiber-optic sensors can be used to sense and detect stimuli in various applications, e.g., chemical applications such as in-situ reactor monitoring of chemical reactions, acidity measurements, and gas analysis (especially of explosive or flammable gases), and physical applications such as temperature, pressure, voltage, and current monitoring, particle measurement, motion monitoring, and imaging. Fiber-optic sensors offer the advantages of immunity to hostile environments, wide bandwidth, compactness, and high sensitivity as compared with other types of sensors.

Typically, a fiber-optic sensor can have one or more optical fibers, a light source, a light detector, and one or more couplers for coupling the light source and light detector to an optical fiber. The light source generates the light that is transmitted to the environment to be sensed (or monitored), and the light detector detects and analyzes light received from the sensed environment. The optical fibers are used to transmit light to and from the sensed environment.

A fiber-optic sensor may be classified as an extrinsic or intrinsic sensor depending on how the sensing and detecting are performed. In an extrinsic sensor, sensing takes place outside of the fiber, and the fiber is used to transmit light to and from the sensing region. In an intrinsic sensor, physical properties of the fiber change, and this change is detected by monitoring amplitude, phase, frequency, or polarization state of the light transmitted through the fiber.

Existing fiber-optic sensors are based on using an optical fiber that is modified in some way. One approach involves applying a sensing material to the probe part of the fiber and allowing the sensed environment to be monitored by changes in the optical properties of the sensing material. This approach is typically used for monitoring a chemical environment. FIG. 1A shows the probe part 1 of a chemical sensor, including an optical fiber 2. A sensing material 3, i.e., a reagent whose light transmission properties, e.g., fluorescence, refractive index, or transmission at wavelength(s) being monitored, changes upon reacting with a target compound, is applied at a terminal end of the optical fiber 2.

Another approach involves removing cladding from a section of an optical fiber and allowing the sensed environment to be monitored by total internal reflection in the unclad region. FIG. 1B shows an unclad region 4 at a terminal end of an optical fiber 5. FIG. 1C shows an unclad region 6 in the middle of an optical fiber 7. For the configuration shown in FIG. 1B, light is transmitted to and detected from the same end 5a of the optical fiber 5. For the configuration shown in FIG. 1C, light is transmitted into the input end 8 of the optical fiber 7 and detected at the output end 9 of the optical fiber 7. In general, this approach lacks robustness and sensitivity because detection is done via evanescent wave only.

Another approach involves making lateral deformations called microbends in the fiber and allowing the sensed environment to be monitored by changes in intensity of light radiating from the microbends. This approach can be used for both chemical and physical sensing.

### SUMMARY OF INVENTION

In one aspect, the invention relates to a fiber-optic sensor probe which comprises an optical fiber terminated with a lens.

In another aspect, the invention relates to a fiber-optic sensor probe which comprises an optical fiber, a lens, and an elongated region formed between the optical fiber and the lens for evanescent probing.

In another aspect, the invention relates to a fiber-optic sensor which comprises a lensed fiber, a light source optically coupled to the lensed fiber so as to send light into the lensed fiber, and a light detector optically coupled to the lensed fiber so as detect light reflected into the lensed fiber.

In another aspect, the invention relates to a fiber-optic sensor which comprises a sensor probe having an optical fiber, a lens, and an elongated region formed between the optical fiber and lens for evanescent probing. The fiber-optic sensor further includes a light source that sends light into the optical fiber, a light detector that detects light reflected into the lens and elongated region, and a coupler for coupling the light source and the light detector to the optical fiber.

In another aspect, the invention relates to a fiber-optic sensor which comprises a first lensed fiber, a second lensed fiber optically coupled to the first lensed fiber, a light source optically coupled to the first lensed fiber so as to send light into the first lensed fiber, and a light detector optically coupled to the second lensed fiber so as to detect light transmitted through the second lensed fiber.

In another aspect, the invention relates to a chemical sensor which comprises an optical fiber terminated with a lens, a light source and a light detector coupled to the optical fiber, and a reagent situated in an optical path of the lens, the reagent having an optical property that changes in response to a chemical stimulus.

In another aspect, the invention relates to a chemical sensor which comprises a pair of sensor probes, each sensor probe having a lens for sensing and an optical fiber for transmitting a light signal, wherein the lenses are optically coupled. The chemical sensor further comprises a light detector coupled to one of the sensor probes, a light source coupled to the other of the sensor probes, and a reagent situated in an optical path of the sensor probes, the reagent having an optical property that changes in response to a chemical stimulus.

In another aspect, the invention relates to a temperature sensor which comprises an optical fiber terminated with a lens, a light source and a light detector coupled to the optical fiber, and a temperature-sensitive material proximate the lens, the temperature-sensitive material having a different refractive index and dn/dT than the lens, where n is refractive index and T is temperature.

In another aspect, the invention relates to an electrical sensor which comprises an optical fiber terminated with a lens, a light source and a light detector coupled to the optical fiber, and a birefringent material proximate the lens, the birefringent material having a polarization state that changes in response to changes in an electrical stimulus. In one embodiment, the electrical stimulus is change in voltage. In another embodiment, the electrical stimulus is change in current.

In another aspect, the invention relates to a motion sensor which comprises an optical fiber terminated with a lens, a light source coupled to the optical fiber so as to send light into the optical fiber, and a transducer coupled to the optical fiber so as to measure an intensity and a frequency of light reflected into the optical fiber.

In another aspect, the invention relates to a mechanical sensor which comprises an optical fiber terminated with a lens, a light source and a light detector coupled to the optical fiber, and an optical cavity having an optical path difference that changes in response to a physical stimulus. In one embodiment, the physical stimulus is change in pressure. In another embodiment, the physical stimulus is change in force. In another embodiment, the physical stimulus is change in acceleration.

Other features and advantages of the invention will be apparent from the following description and the appended claims.

### BRIEF DESCRIPTION OF DRAWINGS

FIGS. 1A-1C show prior-art fiber-optic sensors.

FIG. 2 shows a fiber-optic sensor probe having a convex surface for sensing and/or probing in accordance with one embodiment of the invention.

FIG. 3 shows the sensor probe of FIG. 2 in transmission configuration.

FIG. 4 shows a fiber-optic sensor probe having a convex surface and an extended guiding region for sensing and/or probing in accordance with another embodiment of the invention.

FIG. 5 shows a graph of back-reflection loss as a function of lens thickness and radius of curvature for a diverging lens operated in reflection mode.

FIG. 6A shows an aligning step of a method for making a sensor probe.

FIG. 6B shows a fusion-splicing step of a method for making a sensor probe.

FIG. 6C shows a taper-cutting step of a method for making a sensor probe.

FIG. 6D shows the glass fiber of FIG. 6C after taper-cutting.

FIG. 6E shows a melting-back step of a method for making a sensor probe.

FIGS. 7A-7C show a fiber-optic chemical sensor incorporating the sensor probe of FIG. 2 in a reflection configuration.

FIGS. 8A-8C show a fiber-optic chemical sensor incorporating the sensor probe of FIG. 4 in a reflection configuration.

FIGS. 9A-9C show a fiber-optic chemical sensor incorporating the sensor probe of FIG. 2 in a transmission configuration.

FIG. 10A shows a fiber-optic temperature sensor incorporating the sensor probe of FIG. 2 in a reflection configuration.

FIG. 10B shows a graph of reflection coefficient as a function of temperature for a silica lens having an infinite radius of curvature and embedded in a polymer material.

FIG. 11A shows a voltage/current sensor incorporating the sensor probe of FIG. 2 in a transmission configuration.

FIG. 11B shows a voltage/current sensor incorporating the sensor probe of FIG. 4 in a reflection configuration.

FIG. 12 shows a motion sensor incorporating the sensor probe of FIG. 2 in a reflection configuration.

FIG. 13 shows a mechanical sensor incorporating the sensor probe of FIG. 2 in a reflection configuration.

FIG. 14 shows an alternate arrangement of sensor probes in a transmission configuration.

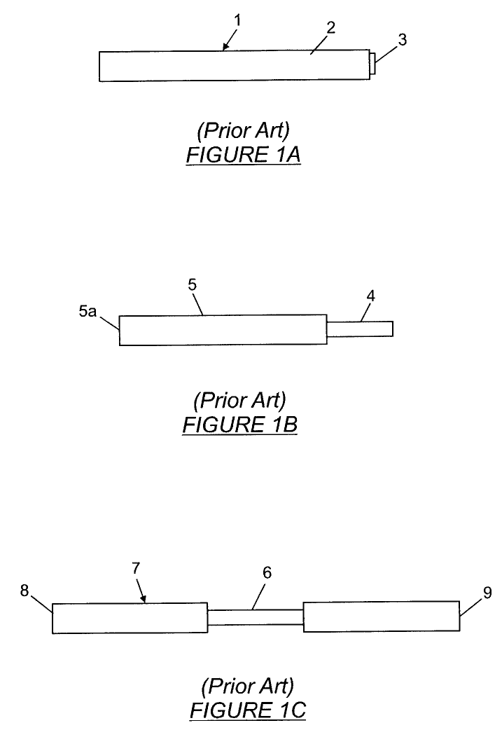

### DETAILED DESCRIPTION

Embodiments of the invention provide a fiber-optic sensor probe having enhanced sensitivity as compared with conventional fiber-optic sensor probes. Embodiments of the invention also provide sensors incorporating the fiber-optic sensor probe of the invention. The enhanced sensitivity of the fiber-optic sensor probe is achieved by use of a lensed fiber. A lensed fiber is an optical fiber terminated with a lens. The sensitivity of the fiber-optic sensor probe is tuned by tailoring the lens geometry and/or coating the lens with a reflective or anti-reflective coating.

Various embodiments of the invention will now be described with reference to the accompanying drawings.

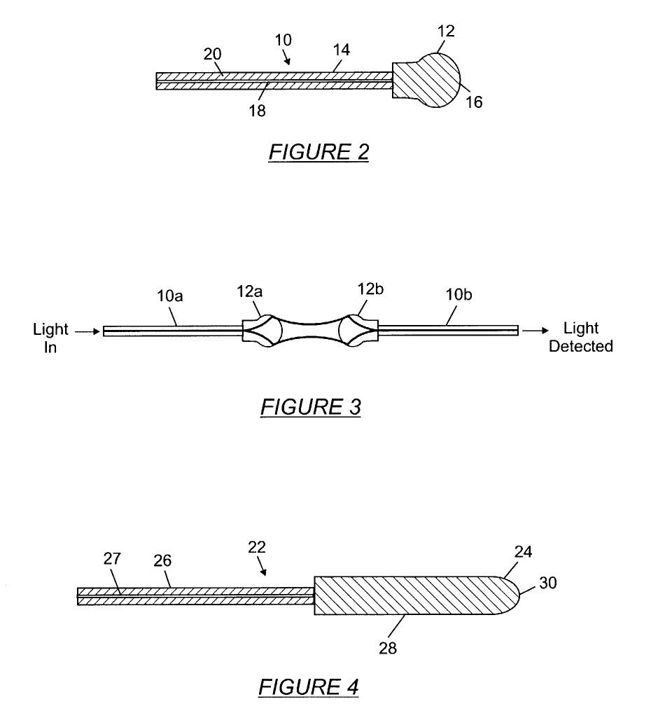

FIG. 2 shows a fiber-optic sensor probe 10 according to one embodiment of the invention. The sensor probe 10 is a lensed fiber having a plano-convex lens 12 attached to, or formed at, the end of an optical fiber 14. The convex surface 16 of the lens 12 is used for sensing and/or probing. The optical fiber 14 has a core 18 and a clad 20 surrounding the core 18, where the core 18 is for transmitting light to or from the convex surface 16. The optical fiber 14 can be any single-mode fiber, including polarization-maintaining fiber (PM fiber), or a multimode fiber. The lens 12 can be made from a material having transparency at the wavelength(s) of interest. Preferably, the lens 12 has a refractive index similar to that of the fiber core 18. For robustness, i.e., protection from fire, explosion, and corrosion, the lens 12 is preferably made of silica or doped silica, e.g., B₂O₃—SiO₂ and GeO₂—SiO₂.

In the reflection mode, the sensor probe 10 is used to transmit light to and detect light from the environment to be sensed. The detected light is decoded to determine the changes in the sensed environment. In the transmission mode, a pair of the sensor probes 10 are needed. FIG. 3 illustrates sensor probes 10a, 10b in transmission configuration. The lenses 12a, 12b of the sensor probes 10a, 10b are optically coupled. The sensor probe 10a is used to transmit light to the sensed environment, and the sensor probe 10b is used to detect light from the sensed environment.

FIG. 4 shows a fiber-optic sensor probe 22 according to another embodiment of the invention. The sensor probe 22 includes an optical fiber 26 with a core 27. The optical fiber 26 is spliced to a coreless optical fiber 28 that is terminated with a lens 24. The lensed fiber 28 provides an extended surface area for evanescent probing. The lensed fiber 28 could be formed from a larger-diameter fiber so that the active area where evanescent probing occurs is increased in comparison to that of the sensor probe (10 in FIG. 2). The lensed fiber 28 could also be formed from a fiber having a diameter that is the same as or smaller than the diameter of the optical fiber 26. The sensor probe 22 has a high back-reflection, e.g., greater than −10 dB, which results in improved sensitivity in comparison to the sensor probe (10 in FIG. 2) in the reflection mode.

The sensor probes 10, 22 (see FIGS. 2, 4) provide several advantages when compared with conventional fiber-optic sensor probes. One advantage provided is that a wide range of lens geometries are possible, and the lenses 12, 24 (see FIGS. 2, 4) can be coated, as needed, with reflective or anti-reflective coating. Thus, the sensitivity of the sensor probes 10, 22 can be tuned by tailoring the geometry of the lenses 12, 24 and/or coating the lenses 12, 24. Another advantage provided is that the convex surfaces 16, 30 (see FIGS. 2, 4) create a high surface area for interaction with the sensed environment. The sensor probe 22 (see FIG. 4) provides an extended surface area for evanescent probing in comparison to the sensor probe 10 (see FIG. 2). Another advantage provided is that in the reflection mode, the properties of the lenses 12, 24 can be used to tailor back-reflection to a desired value without use of reflective coating.

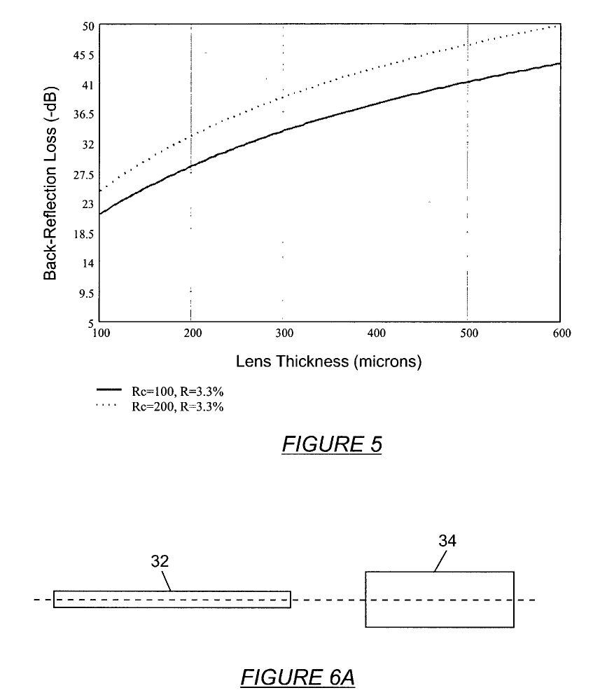

In general, the lenses 12, 24 (see FIGS. 2, 4) can be designed to be collimating, focusing, or diverging, depending on the sensing configuration and sensed environment. Typically, for the reflection mode, it is desirable to maximize back-reflection at the convex surfaces 16, 30 (see FIGS. 2, 4). A diverging lens is most efficient for the reflection mode. The diverging lens can be used to tailor back-reflection to a desired value with or without using reflective coating. FIG. 5 shows a graph of back-reflection as a function of lens thickness and radius of curvature for a diverging lens operated in reflection mode without reflective coating. The calculations are for a wavelength of 1550 nm and silica-air interface. In the case of probing by focusing on a substrate, the lenses 12, 24 can be focusing lenses.

Typically, for the transmission mode, it is desirable to minimize back-reflection at the convex surfaces 16, 30 (see FIGS. 2, 4). The geometry of the lenses 12, 24 (see FIGS. 2, 4) can be selected to limit back-reflection to a desired value. In addition, an anti-reflective coating applied on the lenses 12, 24 can be used to further reduce back-reflection. Typically, for the transmission mode, it is desirable to maximize coupling between the transmitting sensor probe, i.e., the sensor probe carrying light to the sensed environment, and the detecting sensor probe, i.e., the sensor probe receiving light from the sensed environment. Thus, when the sensor probes 10, 22 (see FIGS. 2, 4) are used in a transmission mode, the lenses 12, 24 are preferably collimating or focusing lenses. Preferably, the lens geometries are selected to maximize coupling and anti-reflective coating is used to minimize back-reflection.

The sensor probes 10, 22 (see FIGS. 2, 4) are monolithic devices. One method for fabricating a monolithic sensor probe will now be described.

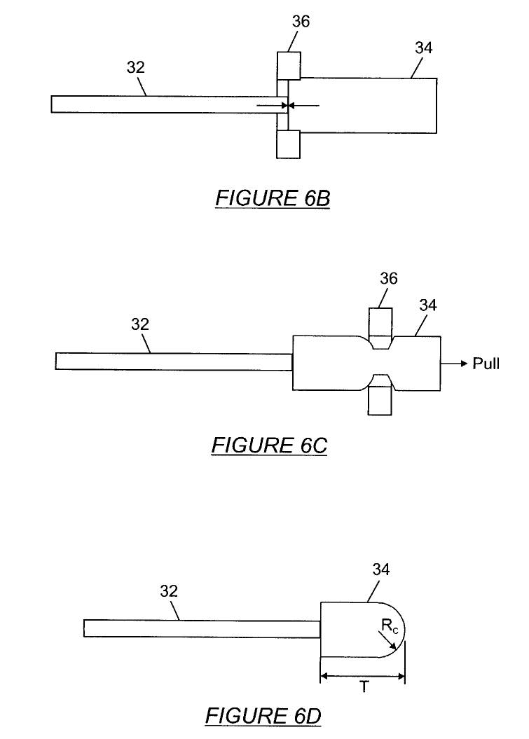

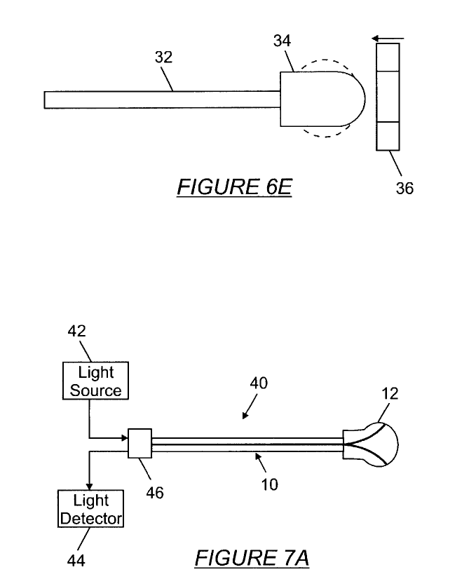

A monolithic sensor probe can be fabricated in three or four steps. In the first step, called the aligning step, an optical fiber and a glass fiber are aligned in opposing relation. FIG. 6A shows an optical fiber 32 aligned with a glass fiber 34. Preferably, the glass fiber 34 is a coreless glass fiber. Preferably, the refractive index of the glass fiber 34 is similar to that of the core of the optical fiber 32. The diameter of the glass fiber 34 can be smaller than, equal to, or greater than the diameter of the optical fiber 32. The second step, called the fusion-splicing step, involves fusing the glass fiber 34 to the optical fiber 32. FIG. 6B shows the glass fiber 34 being fused to the optical fiber 32. The process involves bringing the opposing ends of the glass fiber 34 and optical fiber 32 together and using a heater 36, e.g., a tungsten filament, to heat and fuse the opposing ends.

After joining the glass fiber 34 to the optical fiber 32, the glass fiber 34 is then shaped into a lens. Thus, the third step, called taper-cutting, involves shaping the glass fiber 34 into a lens. As shown in FIG. 6C, taper-cutting involves moving the heater 36 along the glass fiber 34 to taper-cut the glass fiber 34. While moving the heater 36 along the glass fiber 34, the glass fiber 34 is pulled in a direction away from the optical fiber 32 to accomplish the taper-cut. FIG. 6D shows the glass fiber 34 after taper-cutting. The glass fiber 34 is taper-cut such that the desired lens thickness and radius of curvature is achieved. In general, the radius of curvature obtained by taper-cutting is small. To make a lens with a larger radius of curvature, an additional step, called melting-back, is needed. In the melting-back step, illustrated in FIG. 6E, the heater 36 is moved toward the taper-cut end of the glass fiber 34 to form a larger radius of curvature, as shown by the dotted lines.

The following are various examples of fiber-optic sensors incorporating the sensor probes described above.

### Chemical Sensors

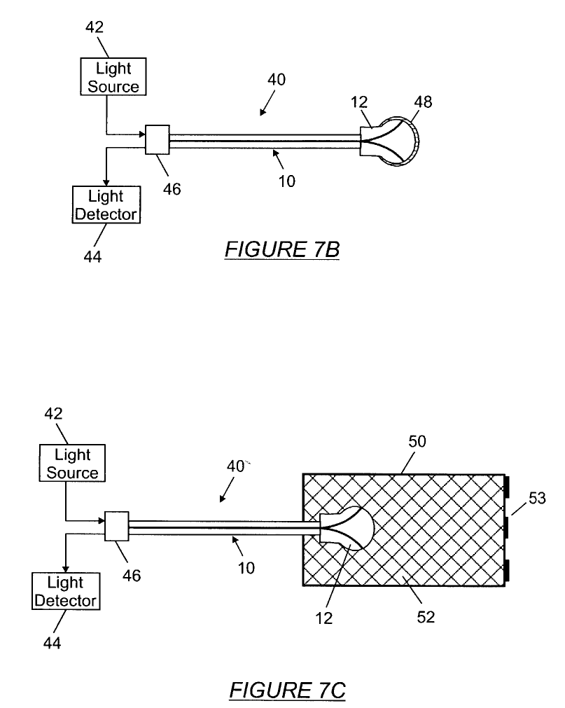

FIG. 7A shows a chemical sensor 40 incorporating the sensor probe 10. The chemical sensor 40 includes a light source 42, a light detector 44, and a coupler 46, e.g., a bifurcated fiber, for coupling the light source 42 and light detector 44 to the sensor probe 10. If multiple wavelengths are to be transmitted through the sensor probe 10, the light source 42 may include a wavelength-division multiplexer (WDM). In this case, the detector 44 should have the capability to analyze multiple wavelengths.

In reflection mode, light is transmitted from the light source 42 to the sensor probe 10. The light exits the sensor probe 10, enters into the chemical environment to be monitored or analyzed, and is reflected back into the sensor probe 10. In this embodiment, either the chemical environment will modify the reflected light in some way, or the physical properties of the sensor probe 10 will change in response to changes in the chemical environment. The reflected light travels to the light detector 44, where it is detected and decoded to determine the changes in the chemical environment.

The chemical sensor 40 may optionally include a sensing material or reagent (48 in FIG. 7B) whose light transmission properties, e.g., fluorescence, refractive index, or transmission at wavelength(s) being monitored, change upon reacting with a target compound. The reagent (48 in FIG. 7B) may be applied on the lens 12 so that the light reflected back into the sensor probe 10 is modified as the chemical environment being monitored and/or analyzed changes.

Alternatively, as shown in FIG. 7C, the chemical sensor 40 may be inserted in a reaction cell 50 containing a reagent 52, such as described above. The cell 50 includes a semi-permeable membrane 53 through which a chemical being detected can flow into the cell 50.

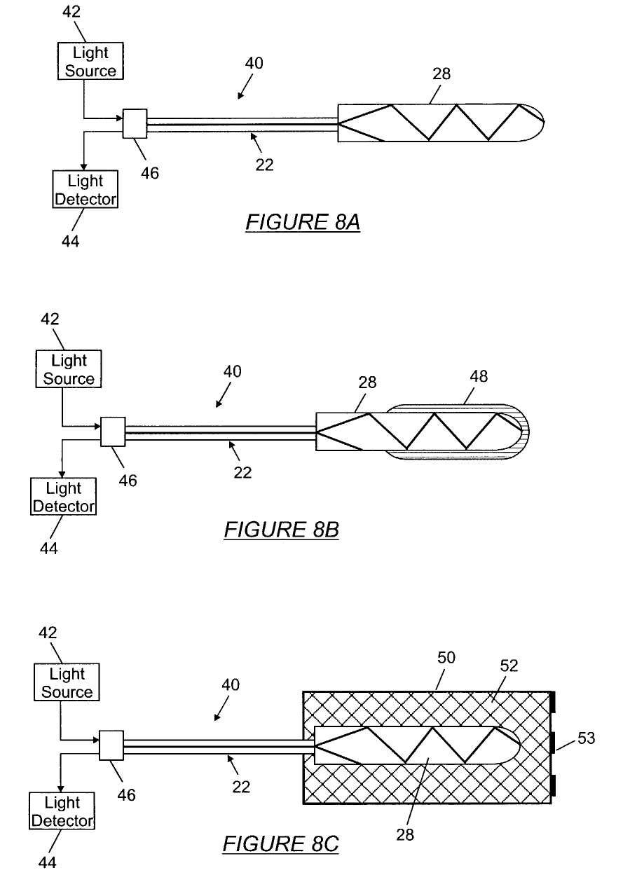

Another modification that can be made to the chemical sensor 40 is to replace the sensor probe 10 with the sensor probe 22, as shown in FIGS. 8A-8C. The sensor probe 22 provides increased surface area for interaction with the sensed environment. The sensor probe 22 is also better suited for the reflection mode because it has a high return loss.

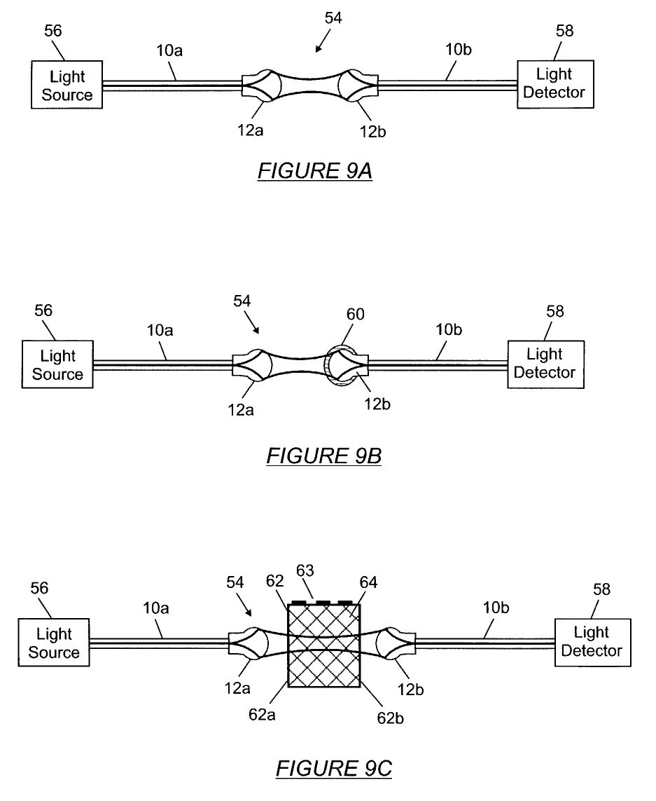

FIG. 9A shows a chemical sensor 54 in transmission configuration. In this configuration, the chemical sensor 54 includes a pair of sensor probes 10, one for transmitting and the other for detecting. For convenience, the characters referencing the transmitting sensor probe or parts of the transmitting sensor probe will have the suffix “a.” Similarly, the characters referencing the detecting sensor probe or parts of the receiving sensor probe will have the suffix “b.”

The chemical sensor 54 includes a light source 56 coupled to the sensor probe 10a and a light detector 58 coupled to the sensor probe 10b. The light source 56 can include a WDM if using multiple wavelength. In this case, the detector 58 can be a spectrum analyzer or other suitable detector for detecting multiple wavelengths. The sensor probes 10a, 10b are arranged such that their optical axes are substantially aligned and their lenses 12a, 12b are spaced apart, allowing light to be coupled between the lenses 12a, 12b.

In transmission mode, light is transmitted from the light source 56 to the sensor probe 10a. The light exits the sensor probe 10a into the chemical environment being monitored and/or analyzed. In this embodiment, either the chemical environment will modify the light in some way, or the physical properties of the sensor probe 10b will change in response to changes in the chemical environment. The light is then transmitted through the sensor probe 10b to the light detector 58, where it is detected and decoded to determine the changes in the chemical environment.

The chemical sensor 54 may optionally include a sensing material or reagent (60 in FIG. 9B) whose light transmission properties, e.g., fluorescence, refractive index, or transmission at wavelength(s) being monitored, change upon reacting with a target compound. The reagent (60 in FIG. 9B) may be applied on the lens 12b so that the light entering into the sensor probe 10b is modified as the chemical environment being monitored and/or analyzed changes. (The reagent may also be applied to the lens 12a.)

Alternatively, as shown in FIG. 9C, a reaction cell 62 containing a reagent 64 may be positioned in between the lenses 12a, 12b. The windows 62a, 62b of the reaction cell 62 are transparent at the wavelengths of interest, allowing light to be transmitted from the sensor probe 10a into the cell 62 and out of the cell 62 into the sensor probe 10b. Alternatively, the lenses 12a, 12b can be embedded in the cell 62, eliminating the need for transparent windows 62a, 62b. The reaction cell 62 includes a semi-permeable membrane 63 through which a chemical being detected can flow into the cell.

Another modification that can be made to the chemical sensor 54 is to replace the pair of sensor probes 10 with a pair of the sensor probe 22 (shown in FIG. 4). The sensor probe 22 provides increased surface area for interaction with the sensed environment.

### Temperature Sensor

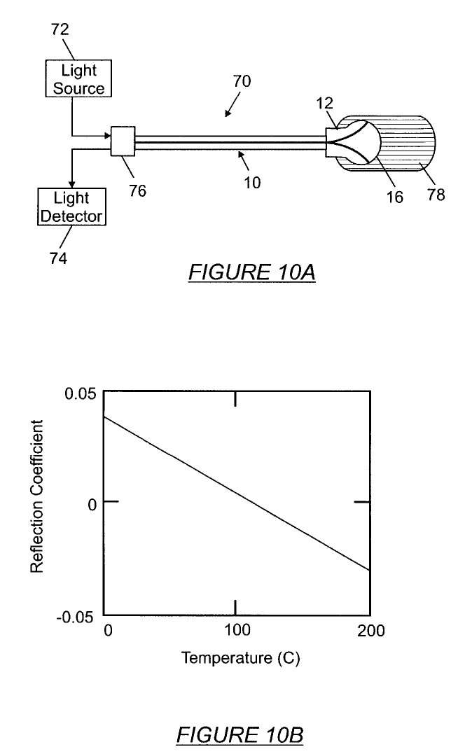

FIG. 10A shows a fiber-optic temperature sensor 70 incorporating the sensor probe 10. The temperature sensor 70 includes a light source 72, a light detector 74, and a coupler 76, e.g., a bifurcated fiber, for coupling the light source 72 and light detector 74 to the sensor probe 10. The lens 12 is embedded in a temperature-sensitive material 78. The material 78 has a different refractive index and different dn/dT than the lens material, where n is refractive index and T is temperature. As an example, the material 78 can be a polymer, which typically has a negative dn/dT, or an inorganic material, such as sol-gel with a positive dn/dT.

In operation, light is transmitted from the light source 72 to the sensor probe 10. The light exits the convex surface 16 into the material 78 and is reflected back into the sensor probe 10 for detection at the light detector 74. The light reflected back into the sensor probe 10 is affected by changes in refractive index of the material 78, where the refractive index of the material 78 changes with temperature of the sensed environment. FIG. 10B shows an example of change in reflection coefficient due to temperature variation at a silica lens (n=1.457, dn/dT=10⁻³/° C.) having an infinite radius of curvature and embedded in a polymer material (n=1.55; dn/dT=−10⁻³/° C.).

### Voltage/Current Sensor

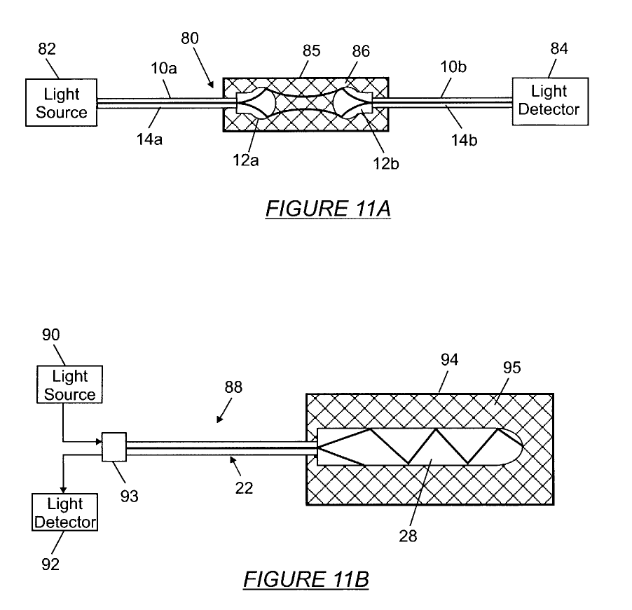

FIG. 11A shows a voltage/current sensor 80 in transmission configuration. The voltage/current sensor 80 includes a pair of sensor probes 10 (a pair of the sensor probes 22 in FIG. 4 can also be used): one for transmitting and the other for detecting. For convenience, the characters referencing the transmitting sensor probe or parts of the transmitting sensor probe will have the suffix “a.” Similarly, the characters referencing the detecting sensor probe or parts of the receiving sensor probe will have the suffix “b. The voltage/current sensor 80 includes a light source 82 coupled to the sensor probe 10a and a light detector 84 coupled to the sensor probe 10b. The sensor probes 10a, 10b are arranged such that their optical axes are substantially aligned and their lenses 12a, 12b are spaced apart.

In one embodiment, the light source 82 is a polarized light source, the optical fibers 14a, 14b are PM fibers, and the detector 84 is a polarization analyzer. The lenses 12a, 12b are submerged in a cell 85 filled with a sensing material 86 that is birefringent, e.g., ferroelectric or liquid crystal. Changes in current and/or voltage will change the polarization state of the sensing material 86. This change in polarization will be sensed by the detector 84 as a reduction in light intensity compared to a reference state where there is no applied electromagnetic field. Alternatively, an unpolarized light source can be used, and the sensor 80 can evaluate the relative ratio of two polarizations.

FIG. 11B shows a voltage/current sensor 88 in a reflection configuration. The voltage/current sensor 88 includes a light source 90 coupled to the sensor probe 22, and a light detector 92 coupled to the sensor probe 22 (the sensor probe 10 in FIG. 2 can also be used, but the sensor probe 22 generally provides enhanced sensitivity in the reflection mode.) The lensed fiber 28 is inserted into a cell 94 filled with a birefringent material 95. The light detector 92 could be a polarization analyzer for analyzing the polarization state of the light reflected from the cell 94 into the sensor probe 22.

### Motion Sensor

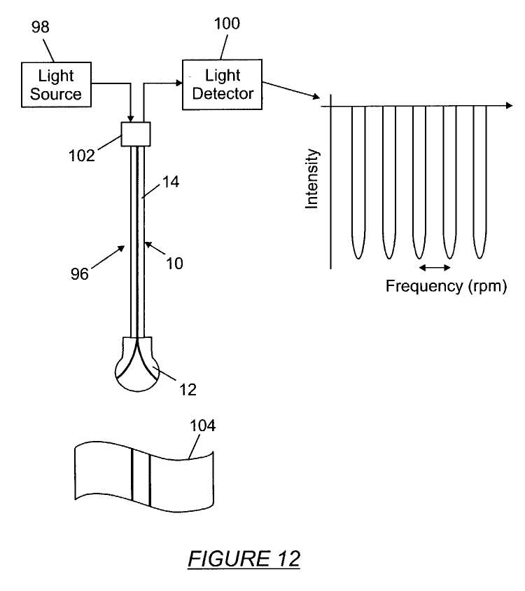

FIG. 12 shows a motion sensor 96 in reflection mode with a light source 98 and light detector 100 coupled to the sensor probe 10 by a coupler 102. Typically, the light detector 100 is a transducer. The sensor probe 10 detects motion of a moving part 104 that is encoded and that modulates the light coming out of the sensor probe 10. The light is retro-reflected back and passed through the coupler 102, such as a 3 dB directional coupler, into the transducer 100. The output of the transducer 100, i.e., intensity vs. frequency plot, is shown in the figure.

The fiber 14 and lens 12 can be made of high silica glass so that the motion sensor 96 can be exposed to harsh environment. The coupler 102 can be made of polymer, because it is away from the lens 12, thus reducing the cost of the sensor. The sensor probe (22 in FIG. 4) can also be used instead of the sensor probe 10. The sensor probe (22 in FIG. 4) generally provides enhanced sensitivity in comparison to the sensor probe 10 when used in the reflection mode.

### Mechanical Sensor

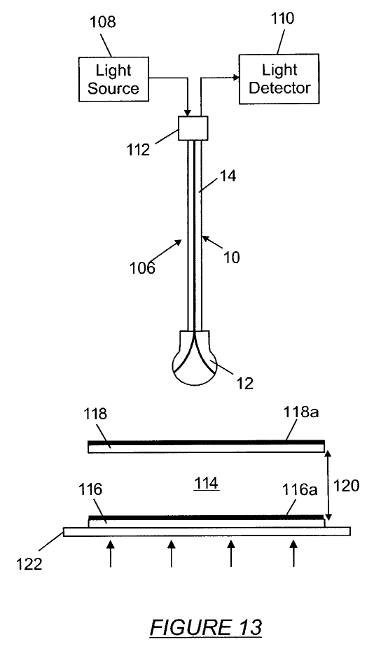

FIG. 13 shows a mechanical sensor 106 in reflection mode with a light source 108 and detector 110 coupled to the sensor probe 10 by a coupler 112. The sensing is based on monitoring optical path difference changes in a Fabry-Perot cavity 114 that is made of two mirrors 116, 118. Low-reflectance coatings 116a, 118a are applied on the glass or other substrate (e.g., polymer) 116, 118, respectively. The changes in optical path difference 120 are monitored using intereferometric fringe pattern analysis. Fringes can be analyzed using spectral domain or phase domain processing (using either temporal fringe formation or spatial fringe formation). By measuring the round-trip phase shift of the reflected optical power in the Fabry-Perot cavity 114, optical path difference 120 can be calculated.

As shown in the figure, the mirror 116 is mounted on a pressure sensing diaphragm 122, which moves along with mirror 116 in response to pressure. Thus, the mechanical sensor 106 senses change in pressure. Alternatively, if the diaphragm 122 is replaced by a weight, the cavity 114 can sense acceleration, or force in general.

### Other Modifications

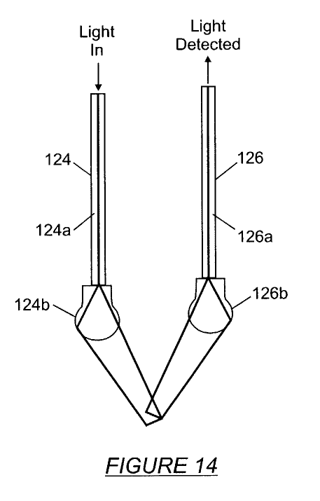

Several modifications can be made to the sensors described above which are within the scope of the invention. The underlying principle of the invention is the use of a lensed fiber to achieve enhanced sensitivity. One example of a modification that can be made is the way the lensed fibers or sensor probes are arranged in the transmission mode, i.e., the optical axes of the sensor probes do not have to be always aligned. FIG. 14 shows an alternative configuration where the optical axes of the optical fibers 124a, 126a of the sensor probes 124, 126 are intentionally misaligned with respect to the center of curvature of the lenses 124b, 126b to induce field angle. This type of configuration is particularly suitable for monitoring changes in surface properties of an element, such as an element that needs to be monitored for wear and tear.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A fiber-optic sensor probe, comprising:
an optical fiber terminated with a lens.

2. The fiber-optic sensor probe of claim 1, further comprising a reagent having an optical property that changes in response to a chemical stimulus.

3. The fiber-optic sensor probe of claim 2, wherein the reagent is applied on a surface of the lens.

4. The fiber-optic sensor probe of claim 2, wherein the reagent is contained in a cell having a semi-permeable membrane for interaction with the chemical stimulus.

5. The fiber-optic sensor probe of claim 4, wherein the lens is embedded in the cell.

6. The fiber-optic sensor probe of claim 1, further comprising a birefringent material proximate to the lens, the birefringent material having a polarization state that changes in response to an electrical stimulus.

7. The fiber-optic sensor probe of claim 6, wherein the optical fiber is a polarization-maintaining fiber.

8. The fiber-optic sensor probe of claim 1, further comprising an optical cavity proximate to the lens, the optical cavity having an optical path difference that changes in response to a physical stimulus.

9. The fiber-optic sensor probe of claim 8, wherein the optical cavity comprises a pair of spaced-apart, low-reflectance mirrors.

10. The fiber-optic sensor probe of claim 1, wherein the optical axis of the optical fiber is misaligned with respect to a center of curvature of the lens to induce a field angle.

11. The fiber-optic sensor probe of claim 1, further comprising a temperature-sensitive material proximate to the lens, the temperature-sensitive material having a different refractive index and dn/dT than the lens, where n is refractive index and T is temperature.

12. The fiber-optic sensor probe of claim 1, further comprising a reflective material applied on a surface of the lens.

13. The fiber-optic sensor probe of claim 1, further comprising an anti-reflective material applied on a surface of the lens.

14. The fiber-optic sensor probe of claim 1, wherein the lens comprises a convex surface.

15. The fiber-optic sensor probe of claim 14, wherein a thickness and a radius of curvature of the lens are selected such that back-reflection at the convex surface is maximized for a selected wavelength.

16. A fiber-optic sensor probe, comprising:
an optical fiber;
a lens; and
an elongated region formed between the optical fiber and the lens for evanescent probing.

17. The fiber-optic sensor probe of claim 16, further comprising a reagent having an optical property that changes in response to a chemical stimulus.

18. The fiber-optic sensor probe of claim 17, wherein the reagent is applied on a surface of the elongated region.

19. The fiber-optic sensor probe of claim 17, wherein the reagent is applied on a surface of the lens.

20. The fiber-optic sensor probe of claim 17, wherein the reagent is contained in a cell having a semi-permeable membrane for interaction with the chemical stimulus.

21. The fiber-optic sensor probe of claim 20, wherein the elongated region is embedded in the cell.

22. The fiber-optic sensor probe of claim 16, further comprising a birefringent material proximate to the elongated region, the birefringent material having a polarization state that changes in response to an electrical stimulus.

23. The fiber-optic sensor probe of claim 22, wherein the optical fiber is a polarization-maintaining fiber.

24. The fiber-optic sensor probe of claim 16, further comprising an optical cavity proximate to the elongated region, the optical cavity having an optical path difference that changes in response to a physical stimulus.

25. The fiber-optic sensor probe of claim 24, wherein the optical cavity comprises a pair of spaced-part, low-reflectance mirrors.

26. The fiber-optic sensor probe of claim 16, further comprising a reflective material applied on a surface of the elongated region and the lens.

27. The fiber-optic sensor probe of claim 16, further comprising an anti-reflective material applied on a surface of the elongated region and the lens.

28. The fiber-optic sensor probe of claim 16, further comprising a temperature-sensitive material proximate to the elongated region, the temperature-sensitive material having a different refractive index and dn/dT than the second optical fiber, where n is refractive index and T is temperature.

29. A fiber-optic sensor, comprising:
a lensed fiber;
a light source optically coupled to the lensed fiber so as to send light into the lensed fiber; and
a light detector optically coupled to the lensed fiber so as to detect light reflected into the lensed fiber.

30. The fiber-optic sensor of claim 29, further comprising a reagent in an optical path of the lensed fiber that has an optical property that changes in response to a chemical stimulus.

31. The fiber-optic sensor of claim 29, further comprising a birefringent material in an optical path of the lensed fiber that has a polarization state that changes in response to an electrical stimulus.

32. The fiber-optic sensor of claim 31, wherein a fiber portion of the lensed fiber is polarization-maintaining.

33. The fiber-optic sensor of claim 31, wherein the light detector comprises a polarization analyzer.

34. The fiber-optic sensor of claim 31, wherein the light source generates polarized light.

35. The fiber-optic sensor of claim 29, further comprising an optical cavity in an optical path of the lensed fiber that has an optical path difference that changes in response to a physical stimulus.

36. The fiber-optic sensor of claim 29, wherein the light detector is a transducer that measures an intensity and a frequency of the light detected from the lensed fiber.

37. The fiber-optic sensor of claim 29, further comprising a temperature-sensitive material in an optical path of the lensed fiber, the temperature-sensitive material having a different refractive index and dn/dT than a lens portion of the lensed fiber, where n is refractive index and T is temperature.

38. A fiber-optic sensor, comprising:
a sensor probe comprising an optical fiber, a lens, and an elongated region formed between the optical fiber and lens for evanescent probing;
a light source that sends light into the optical fiber;
a light detector that detects light reflected into the lens and elongated region; and
a coupler for optically coupling the light source and the light detector to the optical fiber.

39. The fiber-optic sensor of claim 38, further comprising a reagent in an optical path of the sensor probe that has an optical property that changes in response to a chemical stimulus.

40. The fiber-optic sensor of claim 38, further comprising a birefringent material in an optical path of the sensor probe that has a polarization state that changes in response to an electrical stimulus.

41. The fiber-optic sensor of claim 40, wherein the optical fiber is a polarization-maintaining fiber.

42. The fiber-optic sensor of claim 40, wherein the light detector comprises a polarization analyzer.

43. The fiber-optic sensor of claim 40, wherein the light source generates polarized light.

44. The fiber-optic sensor of claim 38, further comprising an optical cavity in an optical path of the sensor probe that has an optical path difference that changes in response to a physical stimulus.

45. The fiber-optic sensor of claim 38, wherein the light detector is a transducer that measures an intensity and a frequency of the light detected from the optical fiber.

46. The fiber-optic sensor of claim 38, further comprising a temperature-sensitive material in an optical path of the sensor probe, the temperature-sensitive material having a different refractive index and dn/dT than the elongated region, where n is refractive index and T is temperature.

47. A fiber-optic sensor, comprising:
a first lensed fiber;
a second lensed fiber optically coupled to the first lensed fiber;
a light source optically coupled to the first lensed fiber so as to send light into the first lensed fiber; and
a light detector optically coupled to the second lensed fiber so as to detect light transmitted through the second lensed fiber.

48. The fiber-optic sensor of claim 47, wherein the first lensed fiber has an optical axis substantially aligned with an optical axis of the second lensed fiber.

49. The fiber-optic sensor of claim 47, wherein the first lensed fiber has an optical axis misaligned with an optical axis of the second lensed fiber so as to induce a field angle.

50. The fiber-optic sensor of claim 47, further comprising a reagent in an optical path of the lensed fibers that has an optical property that changes in response to a chemical stimulus.

51. The fiber-optic sensor of claim 47, further comprising a birefringent material in an optical path of the lensed fibers that has a polarization state that changes in response to an electrical stimulus.

52. The fiber-optic sensor of claim 51, wherein fiber portions of the lensed fibers are polarization-maintaining.

53. The fiber-optic sensor of claim 51, wherein the light detector comprises a polarization analyzer.

54. The fiber-optic sensor of claim 51, wherein the light source generates polarized light.

55. The fiber-optic sensor of claim 47, further comprising a temperature-sensitive material in an optical path of the lensed fibers, the temperature-sensitive material having a different refractive index and dn/dT than a lens portion of the second lensed fiber, where n is refractive index and T is temperature.

56. A chemical sensor, comprising:
an optical fiber terminated with a lens;
a light source and a light detector coupled to the optical fiber; and
a reagent situated in an optical path of the lens, the reagent having an optical property that changes in response to a chemical stimulus.

57. The chemical sensor of claim 56, wherein the reagent is applied on a surface of the lens.

58. The chemical sensor of claim 56, wherein the reagent is contained in a cell having a semi-permeable membrane for interaction with the chemical stimulus.

59. The chemical sensor of claim 58, wherein the lens is embedded in the cell.

60. The chemical sensor of claim 56, wherein the optical fiber is coreless, and further comprising an optical fiber with a core spliced to the coreless optical fiber.

61. The chemical sensor of claim 56, wherein a reflective coating is applied on the lens.

62. A chemical sensor, comprising:
a pair of sensor probes, each sensor probe having a lens for sensing and an optical fiber for transmitting a light signal, wherein the lenses are optically coupled;
a light detector coupled to one of the sensor probes;
a light source coupled to the other of the sensor probes; and
a reagent situated in an optical path of the sensor probes, the reagent having an optical property that changes in response to a chemical stimulus.

63. A temperature sensor, comprising:
an optical fiber terminated with a lens;
a light source and a light detector coupled to the optical fiber; and
a temperature-sensitive material proximate the lens, the temperature-sensitive material having a different refractive index and dn/dT than the lens, where n is refractive index and T is temperature.

64. An electrical sensor, comprising:
an optical fiber terminated with a lens;
a light source and a light detector coupled to the optical fiber; and
a birefringent material proximate the lens, the birefringent material having a polarization state that changes in response to changes in an electrical stimulus.

65. The electrical sensor of claim 64, wherein the optical fiber is a polarization-maintaining fiber.

66. The electrical sensor of claim 64, wherein the light source is a polarized light source.

67. The electrical sensor of claim 64, wherein the light detector is a polarization analyzer.

68. The electrical sensor of claim 64, wherein the electrical stimulus is change in voltage.

69. The electrical sensor of claim 64, wherein the electrical stimulus is change in current.

70. A motion sensor, comprising:
an optical fiber terminated with a lens;
a light source coupled to the optical fiber so as to send light into the optical fiber; and
a transducer coupled to the optical fiber so as to measure an intensity and a frequency of light reflected into the optical fiber.

71. A mechanical sensor, comprising:
an optical fiber terminated with a lens;
a light source and a light detector coupled to the optical fiber; and
an optical cavity having an optical path difference that changes in response to a physical stimulus.

72. The mechanical sensor of claim 71, wherein the optical cavity comprises a pair of spaced-apart, low-reflectance mirrors.

73. The mechanical sensor of claim 71, wherein the physical stimulus is change in pressure.

74. The mechanical sensor of claim 71, wherein the physical stimulus is change in force.

75. The mechanical sensor of claim 71, wherein the physical stimulus is change in acceleration.
